(19) United States
(12) Patent Application Publication
(10) Pub. No.: US 2026/0229388 A1
(43) Pub. Date: Aug. 6, 2026

(54) AIRCRAFT CHARGING CABLE

(71) Applicant: LAPP MULLER SAS, Grimaud (FR)

(72) Inventor: Jaques BESIO, Draguignan (FR)

(21) Appl. No.: 19/146,408

(22) PCT Filed: Jan. 5, 2024
(86) PCT No.: PCT/EP2024/050212

§ 371 Date: Jul. 8, 2025

(30) Foreign Application Priority Data
Jan. 9, 2023 (FR) FR2300221

(51) Int. Cl. H01B 9/00; H01B 7/00; H01B 7/18; H01B 7/30; H01B 7/42

(52) U.S. Cl. CPC H01B 9/006; H01B 7/0009; H01B 7/1825; H01B 7/303; H01B 7/421

(57) ABSTRACT

An electrical cable for the power supply of an on-board electrical device is provided. The electrical cable comprises a central conductor, and a plurality of peripheral conductors disposed around the central conductor, characterized in that at least two among the plurality of peripheral conductors and the central conductor each comprise a central element, and a plurality of peripheral conductive elements each having individual insulation preferably made of thermoplastic elastomer. The peripheral conductive elements is disposed around the central element.

### TECHNICAL FIELD OF THE INVENTION

The present invention generally relates to the field of electrical cables, and particularly to power electrical cables for the power supply of the on-board devices, such as for example onboard aircrafts, boats or any other movable or stationary craft.

### STATE OF THE ART

Electrical cables for power supply are known in the prior art. For example, document CN208444640U discloses a parallel electrical cable attached in a bundle comprising three cores of an electrical cable. However, this cable has the disadvantage of being bulky and of requiring a lot of conductive material for a given power.

### DISCLOSURE OF THE INVENTION

The present invention aims to address the drawbacks of the prior art and to propose a new electrical cable construction that makes it possible to reduce the use of conductive materials for a given power, to improve heat dissipation and that is easier to handle by the operators or the machines, particularly more flexible.

The invention thus relates to an electrical cable for the power supply of an on-board electrical device, comprising:
a central conductor, and
a plurality of peripheral conductors disposed around the central conductor, characterized in that at least two among the plurality of peripheral conductors and the central conductor each comprise:
a central element, and
a plurality of peripheral conductive elements each having individual insulation preferably made of thermoplastic elastomer, the peripheral conductive elements being disposed around the central element.

This makes it possible to propose a cable construction that reduces the use of conductive materials such as copper for a given power, improves heat dissipation and that is easier to handle for the operators or the machines (such as for example a winder-unwinder) and more flexible. This allows the discharge of the temperature due to the transport of the current and the reduction of the sections of the conductors. This cable carries the same amount of energy or power with a copper section reduced by 30% compared to a “standard” cable. For the power cables, the objective is to reduce the section of the conductors while retaining the same amount of energy to be transported and maintaining the same characteristics.

Indeed, it is possible, with this arrangement, to provide for example seven conductors of 24 mm² (i.e. 6×4 mm², that is to say six peripheral conductive elements of a 4 mm² section each, each peripheral conductive element being individually insulated) made of copper instead of seven (solid) conductors of 35 mm² for a conventional cable, while passing the same power or the same energy in the electrical cable. It is thus possible to reduce the electrical losses due to the heating of the conductor and to obtain the same amperage with a smaller cross section.

The heat generated by the reduction in the section is dispersed by the assembly of the components of the electrical cable according to the invention. The power conductor, for example made of copper, is divided into several smaller conductive elements of smaller section. Each conductive element is insulated. The external surface of all these small conductors is larger than that of the solid power conductor and allows more efficient removal of the heat induced by the electric current. For the charging cable, for example, each initial solid conductor of 35 mm² of the prior art is divided for the invention into six conductors of a 4 mm² section. The outer surface of a 35 mm² conductor is of 25 mm²/mm, the outer surface of the six 4 mm² conductors is of 49 mm²/mm. Thus, heat removal is better for the cable according to the present invention, with a larger heat dissipative surface and a smaller section.

The environmental impact of the electrical cable according to the invention is improved, by reducing the amounts of raw materials making up the cable. The reduction of the cross section makes it possible to reduce the weight, the outer diameter and to increase the flexibility of the cable. It also reduces the packaging and transportation costs, as well as all the other costs incurred by the cable in the end user's facilities (cable reel, handling, structure).

Advantageously, the plurality of peripheral conductors and the central conductor are configured to improve the removal of heat dissipated by a transported electric current, said plurality of peripheral conductors and the central conductor having enlarged dissipative surfaces or reduced sections.

This makes it possible to improve the heat removal of the conductors so as to improve the characteristics of the electrical cable.

Advantageously, each of the plurality of peripheral conductors and of the central conductor comprises:
the central element, and
the plurality of peripheral conductive elements each having the individual insulation, the peripheral conductive elements being disposed around the central element.

This makes it possible to optimize the performance of the electrical cable as indicated above.

Advantageously, each of the plurality of peripheral conductors and of the central conductor further comprises an insulating sheath.

This ensures the proper removal of heat to the outside of the electrical cable.

Advantageously, the electrical cable further comprises an outer sheath, preferably made of halogen-free polyurethane.

This ensures the proper removal of heat to the external environment of the electrical cable.

Advantageously, the electrical cable further comprises a plurality of secondary conductors, preferably arranged between two peripheral conductors.

This ensures the electrical transmission for control and/or command functions via secondary conductors.

Advantageously, the central conductor is a neutral or return conductor, and/or the peripheral conductors are phase conductors. This in particular makes it possible to provide symmetry for the electrical cable.

Advantageously, the central element is a non-conductive element. The advantage is in particular the increase in the service life of the cable when it is used in bending. The central element is subjected to tensile and compressive stresses during the bending of the cable; a non-conductive elastomer material thus has better resistance to these stresses than a metal conductive material. In addition, the degradation of this non-conductive central element does not lead to the cessation of the electrical function of the cable, which is the case for a conductive element.

Advantageously, the peripheral conductors are arranged in contact with or in immediate proximity to the central conductor.

Advantageously, the peripheral conductors are equally distributed around the central conductor.

This makes it possible to optimize the arrangement and compactness of the electrical cable.

Advantageously, the peripheral conductors have a center of gravity and are arranged so that their centers of gravity form, in a sectional view, a circle whose center is a center of gravity of the central conductor.

### DESCRIPTION OF THE FIGURE

Other characteristics and advantages of the present invention will appear more clearly upon reading the following detailed description of embodiments of the invention given by way of non-limiting example and illustrated by the appended drawing, in which:

FIG. 1 represents an electrical cable according to the present invention.

FIG. 1 represents the electrical cable 100 according to the present invention.

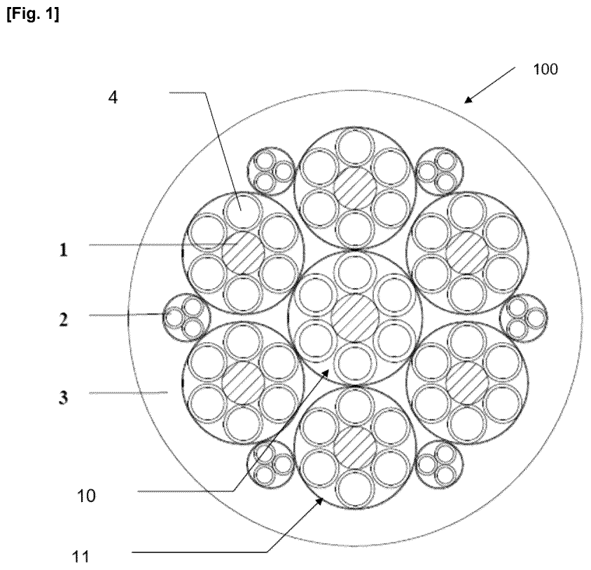

The electrical cable 100 is particularly well suited for transporting electricity to an on-board device, for example an aircraft. It can be used particularly to connect a ground power unit to an airplane.

The electrical frequencies of use are particularly preferably of 400 Hz, and generally less than 100 kHz.

The electrical cable 100 comprises a central conductor 10 and six peripheral conductors 11 disposed around the central conductor 10.

Each of the central 10 and peripheral 11 conductors comprises a central element 1 and six peripheral conductive elements 4 disposed around the central element 1. Each peripheral conductive element 4 is provided with individual insulation preferably made of thermoplastic elastomer.

The peripheral conductive elements 4 and the central element 1 are embedded in a common insulator, for example a halogen-free polyurethane sheath, so as to form the central conductor 10 (or one of the peripheral conductors 11). In one mode preferred embodiment, the peripheral conductors 11 and the central conductor 10 are each formed of the central element 1 and of six peripheral conductive elements 4. The six peripheral conductors have a section of 4 mm², i.e. a total section per peripheral conductor 11 or per central conductor 10 of a 6×4=24 mm² section made of conductive material, such as red copper (particularly extra flexible red copper). Compared to an electrical cable of the prior art in which each of the peripheral conductors or of the central conductor is formed in a solid material of 35 mm², the material gain is of 30%. Furthermore, the section being reduced in the electrical cable 100 of the present invention (compared to the prior art), and each of the conductive elements 4 being individually insulated, the heat dispersion is significantly better, in particular because the dissipative section is larger as indicated above. It is therefore possible to pass the same power in the cable of the prior art with seven solid conductors of an individual 35 mm² section as in the electrical cable 100 according to the present invention with an individual section of the seven conductors of 6×4 mm²=24 mm². Note that the seven conductors 10, 11 here are the central conductor 10 and the six peripheral conductors 11. Thus, the electrical cable 100 according to the present invention is more flexible, consumes less raw material and has the other advantages indicated above.

For the cable 100 according to the invention, the technical characteristics are for example an operating voltage of 200 volts between phase for the conductors 10, 11, and of 115 volts between phase and neutral for the conductors 10, 11. The admissible linear resistance for two conductors 10, 11 is typically of 260 A.

The maximum admissible temperature on the core of the electrical cable 100 is of 80° C. or 100° C. The theoretical voltage drop for 90 kVA is of 6 volts maximum over 25 meters of cable 100.

In the given example, the operating temperature of the cable 100 is typically from −20° C. to +40° C., with a radius of curvature greater than 200 mm, and a weight of 2.6 kg per meter. Note that the weight of the cable 100 is particularly reduced compared to a cable of the prior art with a solid section of 35 mm², which is approximately 3.5 kg per meter.

The external diameter of the cable 100 is of 36 mm, +/−0.8 mm in the given example.

The electrical cable 100 can further comprise one or several secondary conductors 2, arranged between the peripheral conductors 11. The secondary conductors 2 can be used to transport electric current or control-command signals. The secondary conductors 2 are for example each formed of three secondary elements of a 1 mm² section, made of conductive material such as red copper (particularly extra flexible red copper), and are preferably TPE insulated.

Concerning the secondary conductors 2, the operating voltage is typically of 140 volts and the linear resistance per conductor at 20° C. is less than 21.5 ohms per km, in the given example.

All of the peripheral conductors 11 and of the central conductor 10 are embedded in an overall insulator 3, in contact with the external environment, so as to form the electrical cable 100. The overall insulator 3 is preferably a sheath, for example made of halogen-free polyurethane.

It will be understood that various modifications and/or improvements obvious to those skilled in the art can be made to the different embodiments of the invention described in the present description.

Particularly, reference is made to the possibility of providing a different number of peripheral conductors.

1. An electrical cable for the power supply of an on-board electrical device, comprising:
a central conductor, and
a plurality of peripheral conductors disposed around the central conductor,
characterized in that at least two among the plurality of peripheral conductors and the central conductor each comprise:
a central element, and
a plurality of peripheral conductive elements each having individual insulation preferably made of thermoplastic elastomer, the peripheral conductive elements being disposed around the central element.

2. The electrical cable according to claim 1, wherein the plurality of peripheral conductors and the central conductor are configured to improve the removal of heat dissipated by a transported electric current, said plurality of peripheral conductors and the central conductor having enlarged dissipative surfaces or reduced sections.

3. The electrical cable according to claim 1, wherein each of the plurality of peripheral conductors and of the central conductor comprises:
the central element, and
the plurality of peripheral conductive elements each having the individual insulation, the peripheral conductive elements being disposed around the central element.

4. The electrical cable according to claim 1, wherein each of the plurality of peripheral conductors and of the central conductor further comprises an insulating sheath.

5. The electrical cable according to claim 1, further comprising a plurality of secondary conductors, preferably arranged between two peripheral conductors.

6. The electrical cable according to claim 1, wherein the central conductor is a neutral or return conductor, and/or the peripheral conductors are phase conductors.

7. The electrical cable according to claim 1, wherein the central element is a non-conductive element.

8. The electrical cable according to claim 1, wherein the peripheral conductors are arranged in contact with or in immediate proximity to the central conductor.

9. The electrical cable according to claim 1, wherein the peripheral conductors are equally distributed around the central conductor.

10. The electrical cable according to claim 1, wherein the peripheral conductors have a center of gravity and are arranged so that their centers of gravity form, in a sectional view, a circle whose center is a center of gravity of the central conductor.
